(19) United States
(12) Patent Application Publication
(10) Pub. No.: US 2021/0274967 A1
(43) Pub. Date: Sep. 9, 2021

(54) SYSTEMS AND METHODS FOR AUTOMATED COLD DRIP COFFEE

(71) Applicant: Jova Coffee Company, Lewes, DE (US)

(72) Inventors: Olivia vonNieda, Brookline, MA (US); Jackson Shuttleworth, Boston, MA (US)

(73) Assignee: Jova Coffee Company, Lewes, DE (US)

(21) Appl. No.: 17/169,762

(22) Filed: Feb. 8, 2021

Related U.S. Application Data
(60) Provisional application No. 62/985,752, filed on Mar. 5, 2020.

(51) Int. Cl. A47J 31/52; A47J 31/00; A47J 31/46

(52) U.S. Cl. CPC A47J 31/5255; A47J 31/5253; A47J 31/467; A47J 31/002

(57) ABSTRACT

A method for making cold brew coffee and a system for brewing cold brew coffee is described. A cold brew coffee device may include a water reservoir containing water, a plurality of tubes for transporting water in the water reservoir to a different location, a drip mechanism for receiving water from the water reservoir, a coffee grounds container for receiving water from the drip mechanism, a pump for pumping water from the water reservoir to the drip mechanism, a container for collecting coffee-infused water from the coffee grounds container, a user interface for displaying information and providing alerts, a controller for controlling the pump and user interface, and a battery for providing power to the controller, the pump, and the user interface.

### CROSS-REFERENCE TO RELATED APPLICATIONS

This application claims priority to U.S. Provisional Patent Application No. 62/985,752, filed Mar. 5, 2020, the content of which is hereby incorporated by reference in its entirety.

### TECHNICAL FIELD

The present disclosure relates generally to methods and systems for automated cold drip coffee brewing.

### BACKGROUND

Coffee is a well-known beverage that can be enjoyed in various forms, including hot and cold, and can be prepared in a variety of methods, such as immersion, infusion or drip methods. There are many types of devices that can be used to brew coffee, such as a French press, espresso machine, or Moka pot, using a variety of methods, such as immersion, infusion, pressure, and gravity.

Many of these devices and methods are used for brewing hot coffee, and are not intended to brew cold coffee. For example, a French press is a coffee brewing device that includes a carafe where hot water and coffee grounds, typically course, are combined. A plunger-like device is placed over the combined hot water and coffee grounds, and then pressed downwards, causing the grounds to be separated from the water towards the bottom of the device. The hot water interacts with the grounds, such that the oils, flavors, and essence of the grounds is captured in the hot water. This process uses hot water, usually in the range of 200-210 degrees Fahrenheit, as cold brew methods typically take much longer to extract the flavor from coffee to water. French press and other related hot-brew devices are not ideal for extracting flavor from coffee for cold brew coffee.

One method for brewing cold brew coffee is known as Kyoto style or Dutch style. For this method, the process begins when a container containing water and possibly ice is placed at the top of a device, for example a frame. The bottom of the container is connected to a manually-operated valve with an outlet that allows water from the container to pass through the valve. The valve can be manipulated by a user to manipulate the flow of water; a user set the valve to achieve a high-flow, which may cause the cold brew coffee to be more diluted than a low-flow setting. The water from the container falls into another container containing coffee grounds, where the coffee grounds container is open at the top so that water from the water container is received. As more water drips into the coffee grounds container, the coffee grounds become saturated. As the water passes through the coffee, the water will pick up oils and other flavors from the coffee grounds. Finally, the coffee-infused water will pass through the coffee grounds container into another container, where the cold brew coffee is collected. When complete, a cold brew coffee is ready to consume, either by pouring over ice or serving at room temperature.

There are several disadvantages to the Kyoto-style slow drip method. It is a manually-intensive process, as the user must fill and setup the water container, fill and setup the coffee grounds container, adjust the valve to the user's preferred setting, and set the container for collecting the cold brew coffee. A valve implementation is often imperfect, and must be carefully adjusted to find an ideal flow rate that is subject to water pressure and other factors. The frequent adjustment of the valve is often neglected by the end user, resulting in less-than-ideal cold brew coffee. This process can take anywhere from two to six hours. Additionally, the water flow may vary depending on the type of valve used and other factors that change the pressure on the valve, causing an irregular water flow.

Another method for brewing cold brew coffee is the immersion method. In this method, a mesh container is filled with coffee grounds. The mesh container is inserted into a larger container including water; this allows the water to interact with the coffee grounds in the mesh container. While similar to the French press, this method has the drawback of taking 12 to 24 hours to complete, depending on the user's preferred strength of cold brew coffee. Further, cold brew techniques based on immersion typically have different tasting coffee than drip or gravity based cold brew techniques, as the extraction process differs.

### SUMMARY OF THE DISCLOSURE

The present application describes systems and methods for providing cold brew coffee using a drip technique that uses gravity to transfer oils and other flavors from coffee grounds to water that may then be consumed by an individual.

For example, a method for preparing a cold brew coffee beverage may include receiving a coffee grounds container containing coffee grounds and one or more filters, receiving a preferred cold brew concentrate indication for preparing the cold brew coffee beverage, activating a peristaltic pump to move water from a reservoir containing water to a drip mechanism, and receiving cold brew coffee in a container. The method may include water that is room temperature. The method may include water that has a temperature between 48° F. and 68° F. when the peristaltic pump is activated. The method may include determining a water level of the reservoir, and when the water level reaches a predetermined value, deactivating the peristaltic pump and alerting the user that the cold brew coffee is read. The method may include filtering the water prior to moving the water from the reservoir to the peristaltic pump. The method may include filtering the water after the water passes through the peristaltic pump. The method may include, prior to activating the peristaltic pump, measuring a first temperature of the water in the reservoir, sending the first temperature to a controller, measuring a second temperature of the water in the reservoir after the first temperature is sent to the controller, and when the second temperature falls within a predefined range, activating the peristaltic pump.

As another example, a cold brew coffee device may be configured to prepare a cold brew coffee beverage, where the cold brew coffee device may include a water reservoir containing water, a plurality of tubes for transporting water in the water reservoir to a different location, a drip mechanism configured to receive water from the water reservoir, a coffee grounds container configured to receive water from the drip mechanism, wherein the coffee grounds container contains coffee grounds, a peristaltic pump configured to pump the water in the water reservoir to the drip mechanism, a container for collecting coffee-infused water from the coffee grounds container, a user interface configured to display information, a controller configured to control the peristaltic pump and user interface, and further configured to receive the cold brew strength indicator, and a battery configured to provide power to the controller, the peristaltic pump, and the user interface. The cold brew coffee device may include a portable battery configured to be inserted and removed from the cold brew coffee device. The cold brew coffee device may include a temperature sensor configured to obtain a temperature of the water in the reservoir. The cold brew coffee device may include a temperature sensor configured to obtain a first temperature of the water in the water reservoir and obtain a second temperature of the water in the water reservoir, compare the second temperature to a predetermined range, and based on the second temperature falling within the predetermined range, activate the peristaltic pump to pump water from the reservoir to the drip mechanism. The cold brew coffee device of may include a water level sensor configured to determine a water level of the reservoir. The cold brew coffee device may include a controller configured to receive a water level value from the water level sensor and determine when the water level value falls below a predetermined value, and cause the user interface to issue an alert associated with the water level value. The cold brew coffee device may include a filter for filtering the water in the water reservoir. The cold brew coffee device of may include a filter configured to filter the water prior to the water passing through the peristaltic pump. The cold brew coffee device may include a filter configured to filter the water after the water passes through the peristaltic pump. The cold brew coffee device may include an electric plug configured to plug into a wall outlet. The cold brew coffee device may include a drip mechanism including a plurality of outlets, each outlet configured to allow water to pass through the drip mechanism to the coffee grounds container. The cold brew coffee device may include a drip mechanism configured to rotate in response to a command from the controller.

As yet another example, a cold brew coffee device may be configured to prepare a cold brew coffee beverage, the cold brew device including a water reservoir containing water, a plurality of tubes for transporting water in the water reservoir to a different location, a drip mechanism configured to receive water from the water reservoir, a coffee grounds container configured to receive water from the drip mechanism, a peristaltic pump, the peristaltic pump configured to pump the water in the water reservoir to the drip mechanism, a container for collecting coffee-infused water from the coffee grounds container, a user interface configured to display information, a controller configured to control the peristaltic pump and user interface and further configured to receive the cold brew strength indicator and control the peristaltic pump to pump the water at a rate based on the cold brew strength indicator, and a battery configured to provide power to the controller, the peristaltic pump, and the user interface.

### BRIEF DESCRIPTION OF THE FIGURES

FIG. 1 shows a system with a cold brew coffee device according to an embodiment of the present disclosure.

FIG. 2 shows a block diagram of a cold brew coffee device according to an embodiment of the present disclosure.

FIGS. 3A and 3B show a peristaltic pump that may be used with a cold brew coffee device according to an embodiment of the present disclosure.

FIGS. 4A and 4B show user interfaces of a cold brew coffee device according to an embodiment of the present disclosure.

FIG. 5 shows a method for automated brewing cold brew coffee according to an embodiment of the present disclosure.

FIGS. 6A-6C shows various drip mechanisms that may be used in a cold brew coffee device according to an embodiment of the present disclosure.

### DETAILED DESCRIPTION OF SEVERAL EMBODIMENTS

The embodiments disclosed in the present application include a system and method for preparing cold brew coffee. While the present disclosure focuses on preparing cold brew coffee, preparation of other beverages using cold brew techniques is within the scope of this disclosure.

Reference will now be made in detail to exemplary embodiments of the present disclosure, examples of which are illustrated in the accompanying drawings and described herein. In the drawings, like reference numerals are sometimes used to designate like structural elements. It should also be appreciated that the depictions in the figures are diagrammatic and not to scale.

The present disclosure generally relates to systems and methods for making cold brew coffee using a cold brew coffee device. The disclosed systems may include a cold brew coffee device that is configured to brew coffee using a cold brewing method technique. A cold brew coffee device may include a reservoir for holding water, tubing for transporting water in the reservoir to another location, a drip mechanism for distributing water over a coffee filter or grounds container including coffee grounds, a pump for forcing water to move from the reservoir to the drip mechanism, and a container for collecting water that has absorbed oils and other elements from the coffee grounds. The coffee grounds in the coffee filter may be dampened prior to the filter being inserted into the cold brew coffee device, for example by a user who manually performs this process. The dampening process may also be performed by the drip mechanism, which may be configured in for example a “showerhead” configuration that distributes water over an area, and may be used to avoid a scenario where water follows a path through the coffee grounds that avoids most of the grounds in the coffee filter. While different types of pumps may be used, the present disclosure describes a peristaltic pump that may be used to ensure reliable distribution of water throughout the brewing process. As described in the present disclosure, the peristaltic pump may be an off-the-shelf pump, or alternatively may be modified and miniaturized to support a smaller form factor that enables the cold brew coffee device to be transported to different locations.

The cold brew coffee device may include other components to enable the cold brew process to be performed automatically, and either largely without user intervention, or entirely without user intervention. For example, the cold brew coffee device may include a portable battery that may inserted and removed into the cold brew coffee device. The device may also include an electrical cord that is used to plug the device into an electrical outlet. This allows for electrical components in the cold brew coffee device to receive power. The cold brew coffee device may include a user interface including one or more buttons and knobs, and a touch-sensitive display screen. A user may interact with the user interface for example to begin the cold brewing process, select a desired brew concentrate setting, or to change other settings, such as an alarm for notifying a user when a cold brew process is complete.

The cold brew coffee device may include various features to improve usability of the device. For example, the device may include a transceiver for communicating wirelessly with an electronic device, for example over a local Wi-Fi network or through the Internet. This allows a user to start a cold brewing process at a specific time, so that a cold brew beverage is ready when a user arrives at a location where the cold brew coffee device is located.

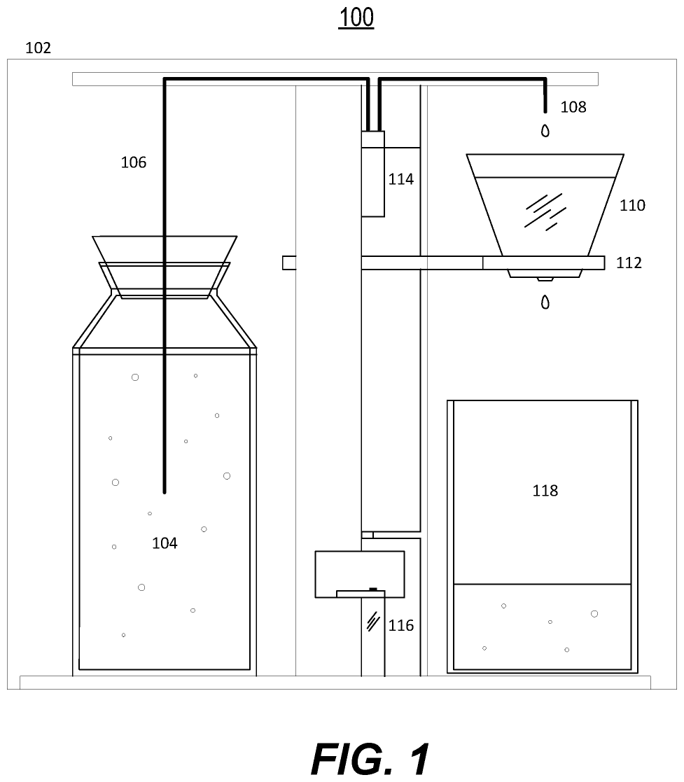

Turning to FIG. 1, a cold brew coffee device 100 for automatically making cold brew coffee is disclosed. A structure 102 includes a water carafe 104 containing water that is used to make cold brew coffee. Tubing 106 extends into the water carafe 104 and is used to transport water from the water carafe 104 to a drip mechanism 108. Drip mechanism 108 receives water from water carafe 104 and distributes it to coffee grounds filter 110. Coffee grounds filter 110 includes coffee grounds, though other types of organic matter may be placed in coffee grounds filter 110. A tray 112 may be used to hold coffee grounds filter 110 in place in order to receive water from water carafe 104. Tray 112 may support and hold coffee grounds filter 110 in place using form-fitting design, such that the coffee grounds filter may be placed securely into tray 112 without further items to secure coffee grounds filter 110. Alternatively, tray 112 may be designed to receive coffee grounds filter 110, or in other embodiments tray 112 may include a screw or other hardware for securing the coffee grounds filter 110 in place.

A pump 114 is used to transport water from water carafe 104 to coffee grounds filter 110. The present embodiment uses a peristaltic pump to pump water from water carafe 104, though other types of pumps may be used. A peristaltic pump may be useful in order to reliably transport water from water carafe 104 to coffee grounds filter 110 in a manner that additional sensors are not needed, based on the purpose and design of a peristaltic pump. As disclosed in the present disclosure, the peristaltic pump may be modified to support a form factor where cold brew coffee device 100 may be packed into a portable format that allows for relocating the device to a different location, whether a different room for example in a home or office, on a trip, or possibly a vacation. For cold brew coffee with a limited flow rate, the components of the peristaltic pump may be miniaturized for embodiments where a portable cold brew device is preferred. Additionally, by using a peristaltic pump, a regular flow of water to the coffee grounds filter may be maintained, ensuring that the brew process requires less time.

Coffee grounds filter 110 includes coffee grounds. Over time, coffee grounds in coffee grounds filter 110 become saturated, and the water flows downward because of gravity. As the water passes through the coffee, oils and other elements from the coffee beans grounds is transferred to the water. At the bottom of coffee grounds filter 110, water is output and falls into container 118. Container 118 collects water that passes through coffee grounds filter 110. Eventually, the coffee-infused water that is collected in container 118 may be poured into another container that an individual may consumer.

Cold brew coffee device 100 also includes a battery 116. In the embodiment shown in FIG. 1, battery 116 is a portable battery that may be inserted and removed to be recharged for example. In other embodiments, cold brew coffee device 100 includes an electrical plug that is plugged into a power outlet to provide power to components requiring power, such as pump 114 and a user interface not shown in FIG. 1.

The cold brew coffee device 100 in FIG. 1 may also include a user interface, not shown. The user interface may include one or more buttons and dials, and a touch-sensitive portion that allows a user to provide feedback using a finger. The user interface may be modified to allow user functionality, for example to specify the flow of water from water carafe 104 to coffee grounds filter 110. For example, the user interface may include drip flow options based either on rate of flow per second, or by volume per second. The user interface may allow a user to set a volume flow of water from the water carafe 104 to the coffee grounds filter 110 at a rate of 0.05 mL per drop, for 1 to 3 mL per minute. For users not as familiar with the metric system, more common terminology, such as 1 drop per second, 1 drop per 2 seconds, 1 drop per 3 seconds, or 1 drop per 4 seconds, may be used to indicate to a user the amount of water flow from carafe 104 to coffee grounds filter 110.

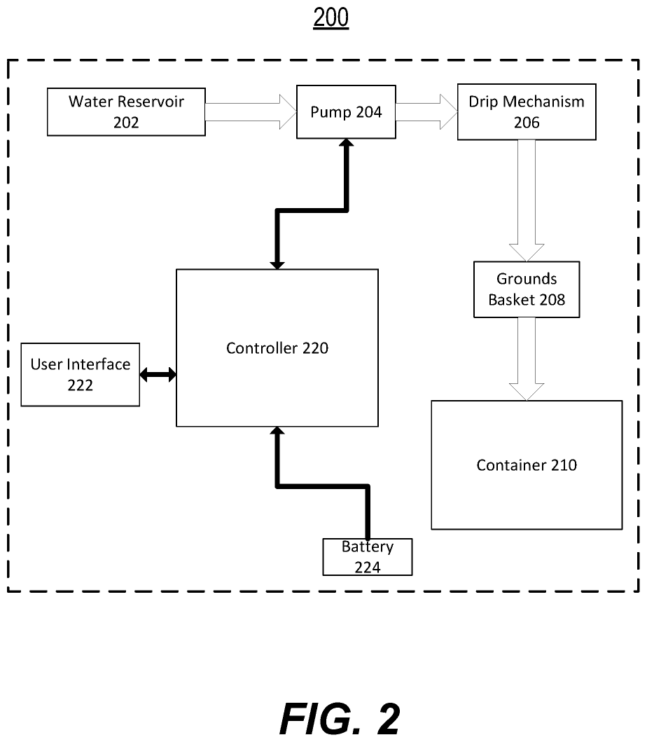

The user interface may also include additional features, for example a timer to notify the user when the cold brewing process is complete. In some embodiments, the peristaltic pump may provide information to a controller or other device that controls peristaltic pump, for example the amount of water that has been processed by the pump. After a certain amount of water has been processed, the controller may determine that the cold brewing process is complete, and provide a notification, such as an audio alarm, visual alarm, or other alarm that is designed to notify a user that the process is complete. The user interface may also be configured to allow a user to perform maintenance, such as providing a button to clear the device of any residual water that may be in tubing or other mechanisms for transporting water from, for example, a water reservoir to a coffee grounds filter. FIG. 2 shows a block diagram of a cold brew coffee device 200 according to an embodiment of the present disclosure. Cold brew coffee device 200 includes a water reservoir 202, a pump 204, a drip mechanism 206, a grounds basket 208, and a container 210. The white arrows represent flow of water in cold brew coffee device 200. A user places water in water reservoir 202, which is then pumped from water reservoir 202 to drip mechanism 206 by pump 204. Water passes through drip mechanism into grounds basket 208, which contains coffee grounds. Water eventually exits grounds basket 208 and drops into container 210, where coffee-infused water is collected.

Also shown in FIG. 2 are components that are not involved in the water flow process, but may be related or control that process. Cold brew coffee device 200 may include controller 220, user interface 222, and battery 224. Controller 220 controls pump 204 and may determine the flow of water from water reservoir 202 to drip mechanism 206, including the flow volume, by providing signals to pump 204. Controller 220 may be in communication with a user interface 222. User interface 222 includes an interface for allowing a user to interact with features of the cold brew coffee device 200. One such feature is a flow rate control, where a user may provide input to device 200 through user interface 222 and specify a desired flow volume. Controller 220 may receive user input and provide signals to pump 204 that changes a flow rate to the desired flow rate as input into the user interface 222 by the user. In alternative embodiments, controller 220 automatically controls the flow of water from water reservoir 202 to drip mechanism 206.

Battery 224 may provide power to controller 220, user interface 222, and pump 204. In some embodiments, battery 224 may include separate power lines to each of controller 220, user interface 222, and pump 204. This may be useful for example if a fault occurs in delivering power to user interface 222. In this embodiment, the device may continue to function, albeit in a state with possibly less features. In other embodiments, an electrical plug not shown may be used instead of a battery to provide power to components found in cold brew coffee device 200. An electrical plug may plug into a wall outlet.

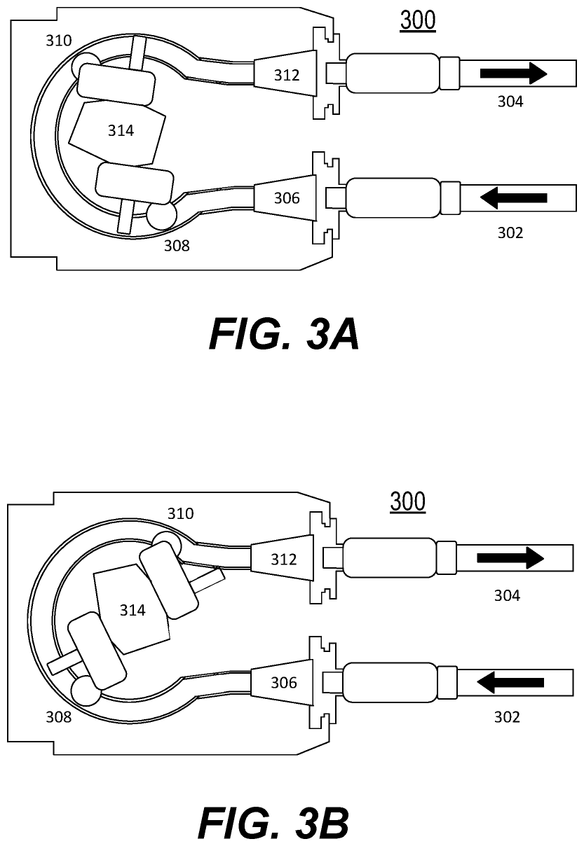

An example of a peristaltic pump that may be used in a cold brew coffee device as described in the present disclosure is shown in FIGS. 3A and 3B. FIG. 3A shows a peristaltic pump 300. Water is pumped into the device through inlet 302 and is eventually pumped out through outlet 304. Water that enters inlet 302 is passed through an inlet control 306 and a tube that connects inlet control 306 to outlet control 312. Rollers 308 and 310 apply pressure to the tubing such that water cannot pass without rollers 308 and 310 moving to a different position. The pressure applied by rollers 308 and 310 cause the tubes compress, causing a vacuum to form that draws water through the tube. Rollers 308 and 310 are driven by a motor 314 that controls the rate at which rollers 308 and 310 move, and controls the volume of water leaving through outlet control 312 and outlet 304. FIG. 3B shows peristaltic pump 300, except that the position of rollers 308, 310, and motor 314 have changed positions. The motor causes rollers 308 and 310 to continue to rotate in a circular manner, where the rollers create a vacuum that causes water to be pumped at a consistent rate.

Other embodiments may use a different kind of pump to move water from a water reservoir to other parts of a cold brew coffee device. Examples of pumps that may be used include diaphragm pumps, piston pumps, and peristaltic pumps. A benefit of using a peristaltic pump is the water is moved through the pump such that nothing but the tubing comes into contact with the water, and reduces risk of water contamination or fluid contaminating the pump. A peristaltic pump's design prevents backflow and removes the need for check valves to ensure flow of water in a single direction. In embodiments where portability is relevant, the peristaltic pump components, including the length of tubing, size of motor, and size of rollers, as well as dimensions of other components such as the outlet and inlet components, may be miniaturized in order to limit the size of the peristaltic pump and its form factor.

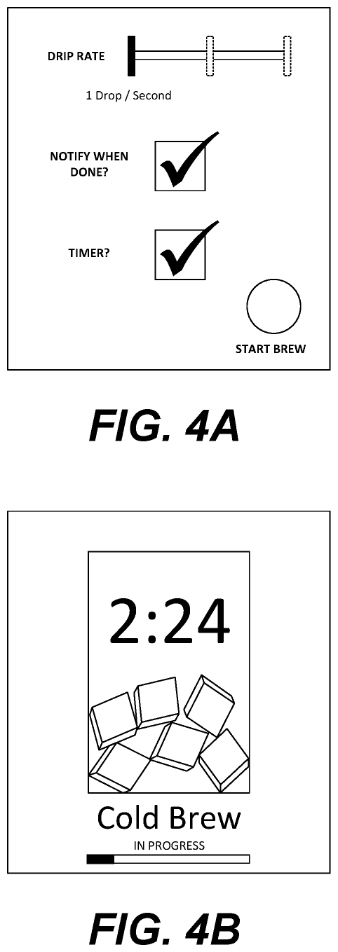

Exemplary user interfaces are shown in FIGS. 4A and 4B. The user interface shown in FIG. 4A includes a touchscreen and various graphical elements, including a slider to allow a user to specify a specific drip rate, for example one drop per second, one drop per two seconds, one drop per three seconds, or one drop per four seconds, as well as allow a user to have the device provide a notification when the cold brewing process is complete. The notification can be audio and/or visual. As an example of an audio notification, the device can be configured to play a certain sound, including sounds that are uploaded to the device by a user, when the cold brewing process is complete. As an example of a visual notification, the user interface can change and alternate between user interfaces to create a flash sensation. This could be useful for example for an individual who is hearing impaired. In the embodiment shown, the notification is optional, such that the user can device to include, or not include, one or more notifications. In other embodiments, the user could save settings that conforms to the settings saved by the user. Further, the user interface may also include a timer option. In such an embodiment, a user interface, as shown for example in FIG. 4B, may be shown. The displayed timer could include a countdown timer, including hours, minutes, and/or seconds, until the cold brew is complete. The user interface may also include a bar tracking the progress of the cold brew. As the cold brew nears completion, more of the bar may be “filled,” indicating to the user when the cold brew process is nearing completion.

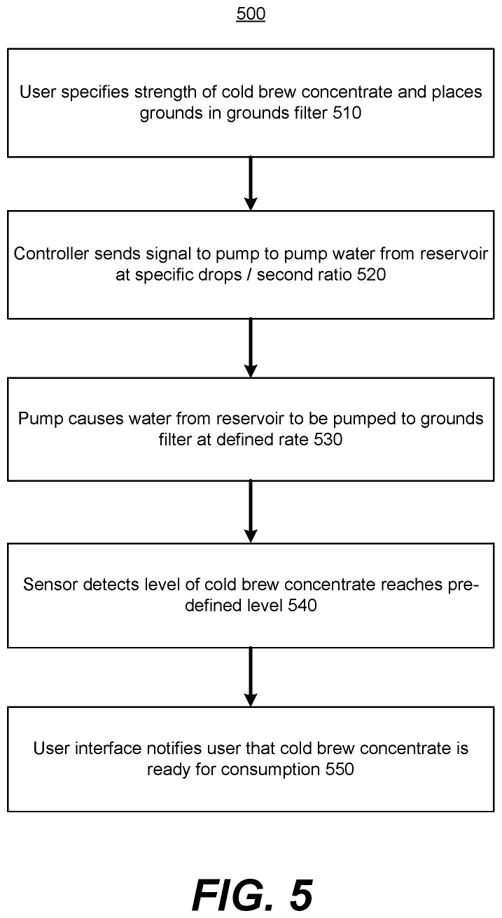

FIG. 5 shows a process 500 of preparing cold brewed coffee using a cold brew coffee device as described in the present disclosure. The process begins at step 510 when a user specifies a strength of cold brew concentrate to create and places coffee grounds in the coffee grounds filter. In some embodiments, a user may place the grounds in a cone-shaped or other shaped device made of plastic or a material harder than paper, with a paper filter over the coffee grounds filter. In other embodiments, the filter may be tube or cylinder-shaped, and include the coffee grounds on all sides of the filter. Paper filters ensure that water being dispensed from a drip mechanism is distributed over the surface area of the coffee grounds. If water drips over a single location in coffee grounds, it is possible for the water to find a path that subsequent water drops follow; if this occurs, other coffee grounds are not dampened, and the quality of the cold brew coffee may be lessened. There are other ways to ensure that the coffee grounds are dampened. For example, a user can mix water with the coffee grounds and manually mix the water and coffee grounds to ensure the coffee grounds are damp. In other embodiments, the drip mechanism is configured to distribution water over the coffee grounds filter to ensure that the coffee grounds are universally dampened. In some embodiments, the coffee grounds filter may include an additional filter at the bottom of the filter that ensures that coffee grounds do not leak into the cold brew coffee. In such embodiments, the additional filter may be made of paper, metal, or other materials.

At step 520, a controller sends a signal to a pump, causing the pump to move water from a water reservoir to a drip mechanism at a rate specified by the user. At described in the present disclosure, a user may specify, through a user interface, a specific volume of water to drip per second, or alternatively may specific a range of coffee strengths, for example, Mild, Regular, or Strong, and the controller adjusts the flow rate based on the user's selection. In some embodiments, the controller may cause an initial flow of water from the water reservoir in an amount that is greater than the user's specified input. This may be desired for example to flood coffee grounds with water. If a user dampens coffee grounds before starting the device, the controller may begin the flow rate based on the user's selection. The process then proceeds to step 530, where the pump causes water to be moved from the water reservoir to the coffee grounds filter at a rate based on the user's input.

In the embodiment disclosed in FIG. 5, a sensor detects a level of cold brew concentrate in the container for holding cold brew coffee at step 540. The container holds coffee-infused water that has passed through the coffee grounds in the coffee grounds filter and passed into the container. In this embodiment, the cold brew device includes a sensor that can track the amount of coffee-infused water that has passed into the container. A sensor may be in communication with the controller, which may determine when the cold brewing process is complete. Upon receiving a signal that the cold brewing process is complete, for example the cold brew level in the container reaching a pre-defined level, the controller may cause a signal to be sent to the user interface, where the user interface may output an audio signal, a visual signal, or both types of signals, to the user. In other embodiments, the controller may cause another component to output an alert signal to the user, where the signal signifies that the cold brew is almost ready, or ready to be consumed. The alert output is performed at step 550. While the embodiment disclosed in FIG. 5 includes a sensor, in other embodiments, the cold brew device does not include a sensor, including a sensor for detecting a level of cold brew concentrate in the container for holding cold brew coffee. The controller may be in communication with the peristaltic pump and track the amount of water that has passed through the pump, enabling the controller for example to provide a notification to the user when the cold brew process is nearing completion.

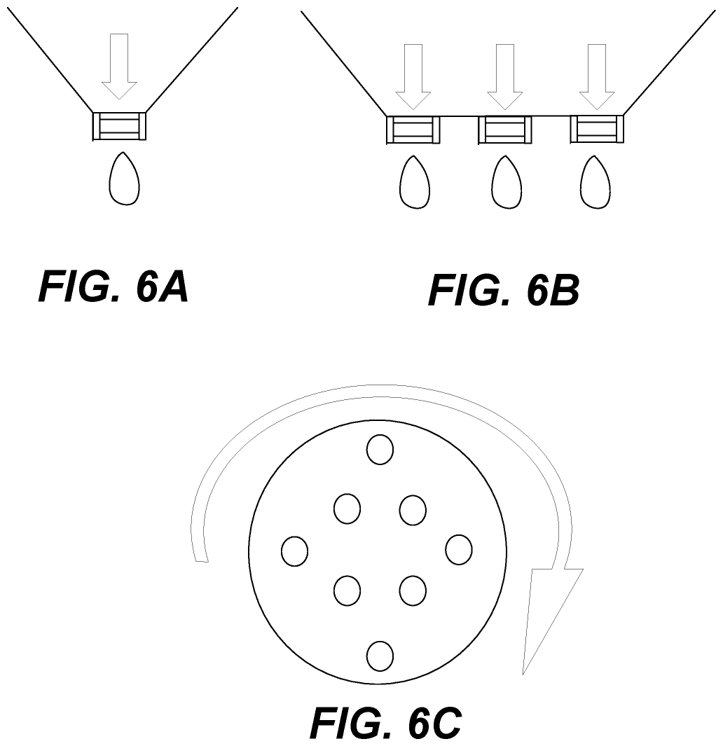

FIGS. 6A through 6C show alternative embodiments for a drip mechanism for providing water to a coffee ground filter including coffee grounds. As shown in FIG. 6A, the drip mechanism includes a single outlet. Water may be pumped from the reservoir to the drip mechanism by a pump, and the drip mechanism then passes the water to the coffee grounds filter at a rate of one drip per time unit. An alternative embodiment is shown in FIG. 6B, which includes three outlets for providing water from the reservoir to the coffee grounds filter. Other embodiments are possible. For example, two outlets, or four or more outlets may be included with the drip mechanism. By adding additional outlets to the drip mechanism, the ability to flood the coffee grounds filter containing coffee grounds is improved. In some embodiments, for example the embodiment shown in FIG. 6B, the drip mechanism may include a component to allow water to pass through all three outlets, and then at a later point in time, block two of the outlets so that water may only pass through the third outlet. In this way, FIG. 6B can be used to replicate the flow of a single outlet, as shown in FIG. 6A, and has the capability to potentially flood the coffee grounds filter.

FIG. 6C shows a showerhead configured drip mechanism. In this embodiment, there are eight outlets in the drip mechanism, such that the drip mechanism can include eight drips of water per time unit. It can be appreciated that the drip mechanism can include more or fewer outlets for water dispensing purposes. The drip mechanism shown in FIG. 6C may include an electrical connection to a controller, and further may be configured to rotate 360 degrees. The controller may send a signal to the drip mechanism to rotate at a specified rate, for example one revolution per time measurement. A benefit of a rotating drip mechanism is better distribution of water over the coffee grounds filter. While drip mechanism is shown to move in a circular manner, other movements and drip mechanism shapes are possible. In some embodiments, the drip mechanism may be square or rectangular shaped, and may include more or fewer outlets than shown in FIG. 6C. By providing additional outlets, the flooding capability of the drip mechanism is improved, and the user may not need to manually dampen the coffee grounds in the coffee grounds filter to prevent irregular water flow and reduced potency of the cold brew concentrate. Other types of drip mechanisms and drip mechanism shapes may be used with the cold brew coffee device as described in the present disclosure. In some embodiments, the drip mechanism may include a misting nozzle for distributing water to the grounds basket or other component containing coffee grounds in mist form.

In certain embodiments, the cold brew device described in the present disclosure does not include sensors. A benefit of not including any sensors besides sensors relating directly to the pump, such as a peristaltic pump, is to minimize cost and risk of component failure. Additionally, by using a peristaltic pump, the flow of water from a reservoir to a coffee grounds filter through a drip mechanism is more precisely obtained, minimizing the need for a sensor to measure water flow to ensure the flow of water is at an ideal rate. In some embodiments, a cold brew coffee device includes sensors for example to track the coffee-infused water level of a container to determine when an alert should be provided to a user that a cold brew process is nearly complete or complete. It can be appreciated that additional sensors may be added, for example to measure the volume of water leaving the reservoir, pump, drip mechanism, and coffee grounds filter. In other embodiments, no additional sensors are added, which may provide a cost benefit.

In the disclosed embodiments, the cold brew coffee device does not include a heating element. A heating element may heat water prior to the start of the brewing process. A benefit of designing a cold brew coffee device to not include a heating element includes: design aesthetics (e.g., a form factor of the cold brew coffee device can be designed in a more pleasing, aesthetic way), cost benefit (e.g., the cost of manufacturing the cold brew coffee device and the cost of use may be minimized by omitting the heating element), and portability (e.g., reducing the number of components in the cold brew coffee device may allow for the device to be more readily designed to allow for portability, for example if a user desires to take the cold brew coffee device on a work trip or vacation).

In the disclosed embodiments, the cold brew coffee device does not include a water filter. In some embodiments, it may be advantageous for the cold brew coffee device to include a water filtration system. Such systems can vary in complexity, including using non-electrical filtering processing versus processes that require electricity to filter water and other liquids with potentially greater purity. In some embodiments, the filter may be added prior to water being transported from a reservoir to a pump, for example a peristaltic pump, and in some embodiments the filter may be added between the pump and the drip mechanism. Ideally, filtering occurs prior to water entering a coffee filter including coffee grounds, but the cold brew coffee device is not limited in such a manner.

In the disclosed embodiments, the cold brew coffee device does not include a manual valve, such as valves used in Kyoto-style cold brewing devices. A benefit of using a peristaltic pump to pump water from a water reservoir to a drip mechanism at a rate defined by a user (or alternatively a default rate determined by the system) is that water may be accurately transported in a manner that does not require manual intervention, as is typically required with a valve in a Kyoto-style cold brewing device. In some embodiments, a valve may be used in addition to a pump's internal mechanisms, though any such valves are automatically operated and not configured by a user.

While various embodiments have been described above, it should be understood that they have been presented by way of example and not limitation. Various changes in form and detail may be made to the embodiments described in the present disclosure, and alternative embodiments may be implemented without departing from the spirit and scope of the present disclosure. For example, other steps may be added or removed from the described flows, and other components may be added or removed from the described systems. It is intended that other implementations are within the scope of the present disclosure. In addition, it should be understood that any figures which highlight the functionality and advantages are presented for exemplary purposes only. The disclosed methods and systems are each flexible and configurable, such that they may be utilized in ways other than that shown in the present disclosure.

What is claimed is:

1. A method for preparing a cold brew coffee beverage comprising:
receiving a coffee grounds container containing coffee grounds;
receiving a preferred cold brew concentrate indication to prepare the cold brew coffee beverage;
activating a pump to move water from a reservoir containing water to a drip mechanism, wherein the water passes through the pump; and
receiving cold brew coffee in a container,
wherein, the water passes through the pump at a rate based on the cold brew concentrate indication, wherein the rate is associated with a volume of water that passes through the pump, wherein the water passes through the drip mechanism to the coffee grounds container, and wherein the cold brew coffee beverage contents is received in the container after passing through the coffee grounds container.

2. The method of claim 1, wherein the pump is a peristaltic pump.

3. The method of claim 2, wherein the pump is a diaphragm pump.

4. The method of claim 1, further comprising determining a water level of the reservoir, and when the water level reaches a predetermined value, deactivating the pump and alerting the user.

5. The method of claim 3, further comprising filtering the water prior to moving the water from the reservoir to the diaphragm pump.

6. The method of claim 1, further comprising filtering the water after the water passes through the pump.

7. The method of claim 5, further comprising:
prior to activating the diaphragm pump:
measuring a first temperature of the water in the reservoir;
sending the first temperature to a controller;
measuring a second temperature of the water in the reservoir after the first temperature is sent to the controller, and
when the second temperature falls within a predefined range, activating the diaphragm pump.

8. A cold brew coffee device configured to prepare a cold brew coffee beverage, the cold brew coffee device comprising:
a water reservoir containing water;
a drip mechanism configured to receive water from the water reservoir;
at least one tube for transporting water in the water reservoir to the drip mechanism;
a coffee grounds container configured to receive water from the drip mechanism, wherein the coffee grounds container is further configured to hold coffee grounds;
a pump configured to pump the water in the water reservoir to the drip mechanism, wherein the water passes through the pump;
a container for collecting coffee-infused water from the coffee grounds container;
a user interface configured to display information, wherein the user interface is configured to receive one or more user inputs, and wherein the user interface is further configured to display a cold brew strength indicator;
a controller configured to control the pump and the user interface, wherein the controller is further configured to receive a cold brew strength indication, wherein the controller is configured to control the peristaltic pump to pump the water at a rate based on the cold brew strength indicator, and wherein the cold brew strength indication is based on the cold brew strength indicator; and
a power source configured to provide power to the controller, the pump, and the user interface.

9. The cold brew coffee device of claim 8, wherein the power source comprises a portable battery, and wherein the portable battery is configured to be inserted and removed from the cold brew coffee device.

10. The cold brew coffee device of claim 8, further comprising a temperature sensor configured to obtain a temperature of the water in the reservoir.

11. The cold brew coffee device of claim 10, wherein the temperature sensor is configured to obtain a first temperature of the water in the water reservoir and obtain a second temperature of the water in the water reservoir, wherein the controller is further configured to compare the first temperature to a predetermined range, compare the second temperature to the predetermined range, and based on the second temperature falling within the predetermined range, activate the pump to pump water from the reservoir to the drip mechanism.

12. The cold brew coffee device of claim 8, further comprising a water level sensor configured to determine a water level of the reservoir.

13. The cold brew coffee device of claim 12, wherein the controller is further configured to receive a water level value from the water level sensor and determine when the water level value falls below a predetermined value, wherein when the controller determines the water level value falls below the predetermined value, the controller causes the user interface to issue an alert associated with the water level value.

14. The cold brew coffee device of claim 8, further comprising a filter for filtering the water.

15. The cold brew coffee device of claim 14, wherein the filter is configured to filter the water prior to the water passing through the pump.

16. The cold brew coffee device of claim 14, wherein the filter is configured to filter the water after the water passes through the pump.

17. The cold brew coffee device of claim 9, further comprising an electric plug configured to plug into a wall outlet, wherein the battery is configured to receive power from the electrical plug.

18. The cold brew coffee device of claim 8, wherein the drip mechanism comprises a misting nozzle.

19. The cold brew coffee device of claim 18, wherein the drip mechanism is configured to rotate in response to a command from the controller.

20. A cold brew coffee device configured to prepare a cold brew coffee beverage, the cold brew device comprising:
a water reservoir containing water;
a plurality of tubes for transporting water in the water reservoir;
a drip mechanism configured to receive water from the water reservoir;
a coffee grounds container configured to receive water from the drip mechanism, wherein the coffee grounds container contains coffee grounds;
a pump, the pump configured to pump the water in the water reservoir to the drip mechanism, wherein the water passes through the pump;
a container for collecting coffee-infused water from the coffee grounds container, wherein the water passes through the coffee grounds prior to being collected in the container;
a user interface configured to display information, wherein the user interface is configured to receive one or more user inputs, and wherein the user interface is configured to display a cold brew strength indicator setting;
a controller configured to control the pump and user interface, wherein the controller is further configured to receive a cold brew strength indication based on the cold brew strength indicator setting, wherein the controller is configured to control the pump to pump the water at a rate based on the cold brew strength indication; and
a power source configured to provide power to the controller, the pump, and the user interface.
